(19) United States
(12) Patent Application Publication
(10) Pub. No.: US 2024/0298236 A1
(43) Pub. Date: Sep. 5, 2024

(54) COMMUNICATION APPARATUS, COMMUNICATION SYSTEM, COMMUNICATION METHOD, AND NON-TRANSITORY COMPUTER READABLE MEDIUM

(71) Applicant: NEC Corporation, Minato-ku, Tokyo (JP)

(72) Inventor: Shinichi Anami, Tokyo (JP)

(73) Assignee: NEC Corporation, Minato-ku, Tokyo (JP)

(21) Appl. No.: 18/268,677

(22) PCT Filed: Mar. 25, 2021
(86) PCT No.: PCT/JP2021/012550

§ 371 Date: Jun. 21, 2023

(51) Int. Cl. H04W 36/30; H04W 36/00; H04W 36/08

(52) U.S. Cl. CPC H04W 36/30; H04W 36/0083; H04W 36/08

(57) ABSTRACT

A communication apparatus according to the present disclosure includes an communication unit that can communicate with a plurality of access points, a reception information acquisition unit that acquires reception information about the communication unit, an influence estimation unit that can estimate an influence on current communication when the communication unit performs active measurement based on the reception information acquired by the reception information acquisition unit, an active measurement unit that performs the active measurement based on a result of the estimation of the influence by the influence estimation unit, a communication quality estimation unit configured to estimate communication quality based on the reception information and a result of the measurement by the active measurement unit, and a communication path control unit that controls a communication path between the communication unit and the plurality of access points based on the communication quality estimated by the communication quality estimation unit.

### TECHNICAL FIELD

The present disclosure relates to a communication apparatus, a communication system, a communication method, and a non-transitory computer readable medium.

### BACKGROUND ART

In recent years, the development of automated transportation systems that automate transportation of products and materials between processes performed at automated warehouses and manufacturing sites has been progressing. In such automated transportation systems, a mobile body that transports products and materials moves while communicating with a plurality of access points set up in the warehouses and manufacturing sites using a communication apparatus mounted on the mobile body.

Patent Literature 1 discloses a technique related to a communication apparatus that can satisfactorily suppress pressure on radio resources in communication using a plurality of frequency bands. Patent Literature 2 discloses a technique related to a wireless communication apparatus that can estimate, in a short time with a simple configuration thereof, communication quality of a wireless communication system different from a wireless communication system currently in communication.

### CITATION LIST

### Patent Literature

Patent Literature 1: Japanese Unexamined Patent Application Publication No. 2018-198384
Patent Literature 2: Japanese Unexamined Patent Application Publication No. 2007-028436

### SUMMARY OF INVENTION

### Technical Problem

In the above-mentioned automatic transportation system, a mobile body transporting products or materials moves while communicating with a plurality of access points set up in warehouses or manufacturing sites by using a communication apparatus mounted on the mobile body. At this time, the mobile body is controlled remotely by wirelessly communicating with the plurality of access points using the communication apparatus.

However, there is a problem that if the communication between the communication apparatus and the plurality of access points is unstable, the mobile body cannot be stably controlled.

An object of the present disclosure is to provide a communication apparatus, a communication system, a communication method, and a non-transitory computer readable medium that can perform stable wireless communication with a plurality of access points.

### Solution to Problem

In an example aspect of the present disclosure, a communication apparatus includes: a communication unit configured to be able to communicate with a plurality of access points: a reception information acquisition unit configured to acquire reception information about the communication unit: an influence estimation unit configured to estimate an influence on current communication when the communication unit performs active measurement based on the reception information acquired by the reception information acquisition unit: an active measurement unit configured to perform the active measurement based on a result of the estimation by the influence estimation unit: a communication quality estimation unit configured to estimate communication quality based on the reception information and a result of the measurement by the active measurement unit; and a communication path control unit configured to control communication paths between the communication unit and the plurality of access points based on the communication quality estimated by the communication quality estimation unit.

In another example aspect of the present disclosure, a communication system includes: a plurality of access points: a server connected to the plurality of access points via a network: the above communication apparatus; and a mobile body on which the communication apparatus is mounted. When the mobile body moves, the communication apparatus moves while switching communication paths between the communication apparatus and the plurality of access points.

In another example aspect of the present disclosure, a communication method includes: acquiring reception information about a communication unit configured to be able to communicate with a plurality of access points: estimating an influence on current communication when the communication unit performs active measurement based on the acquired reception information: performing the active measurement based on a result of the estimation of the influence on the current communication: estimating communication quality based on the reception information and a result of the measurement of the active measurement; and controlling communication paths between the communication unit and the plurality of access points based on the estimated communication quality.

In another example aspect of the present disclosure, a non-transitory computer readable medium storing a program for causing a computer to execute communication processing includes: processing of acquiring reception information about a communication unit configured to be able to communicate with a plurality of access points: processing of estimating an influence on current communication when the communication unit performs active measurement based on the acquired reception information: processing of performing the active measurement based on a result of the estimation of the influence on the current communication: processing of estimating communication quality based on the reception information and a result of the measurement of the active measurement: and processing of controlling communication paths between the communication unit and the plurality of access points based on the estimated communication quality.

### Advantageous Effects of Invention

According to the present disclosure, it is possible to provide a communication apparatus, a communication system, a communication method, and a non-transitory computer readable medium that can perform stable wireless communication with a plurality of access points.

### BRIEF DESCRIPTION OF DRAWINGS

FIG. 1 is a block diagram showing an example of a configuration of a communication system according to a first example embodiment;

FIG. 2 is a block diagram showing an example of a configuration of a communication apparatus according to the first example embodiment:

FIG. 3 is a flowchart for explaining an operation of the communication apparatus according to the first example embodiment:

FIG. 4 is a block diagram showing an example of a configuration of a communication apparatus according to a second example embodiment:

FIG. 5 is a flowchart for explaining an operation of the communication apparatus according to the second example embodiment; and

FIG. 6 is a flowchart for explaining the operation of the communication apparatus according to the second example embodiment.

### EXAMPLE EMBODIMENT

### First Example Embodiment

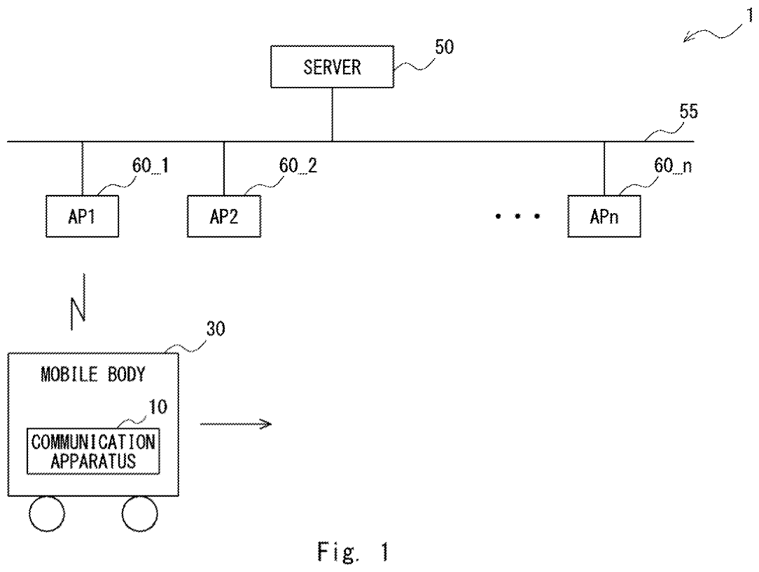

Example embodiments of the present disclosure will be described below with reference to the drawings. FIG. 1 is a block diagram showing an example of a configuration of a communication system according to a first example) embodiment. As shown in FIG. 1, a communication system 1 according to this example embodiment includes a mobile body 30, a server 50, and a plurality of access points 60_1 to 60_n (n is an integer of two or more). A communication apparatus 10 is mounted on the mobile body 30. The server 50 and the plurality of access points 60_1 to 60_n are connected to each other via a network 55.

The mobile body 30 is configured to be movable while communicating wirelessly with the plurality of access points 60_1 to 60_n using the communication apparatus 10. Here, each of the plurality of access points 60_1 to 60_n functions as a master station apparatus and the communication apparatus functions as a slave station apparatus.

The server 50 is configured to remotely control the mobile body 30. For example, a program for remotely controlling the mobile body 30 is stored in the server 50, and the server 50 remotely controls the mobile body 30 by executing the program for remote control. That is, the server 50 remotely controls the mobile body 30 by transmitting control signals to the mobile body 30 via the network 55, the plurality of access points 60_1 to 60_n, and the communication apparatus 10.

When the mobile body 30 moves, the communication apparatus 10 moves while switching communication paths between the communication apparatus 10 and the plurality of access points 60_1 to 60_n. The plurality of access points 60_1 to 60_n can be composed of, for example, a wireless LAN (Local Area Network). For example, the wireless LAN can employ a communication scheme in accordance with the specifications of IEEE (Institute of Electrical and Electronics Engineers) 802.11.

For example, the mobile body 30 is configured to be movable in a predetermined area including a warehouse or a factory while carrying objects to be transported such as products or materials. At this time, an automatic transportation system in which the mobile body 30 automatically transports the objects to be transported can be achieved by using the communication system 1 according to this example embodiment.

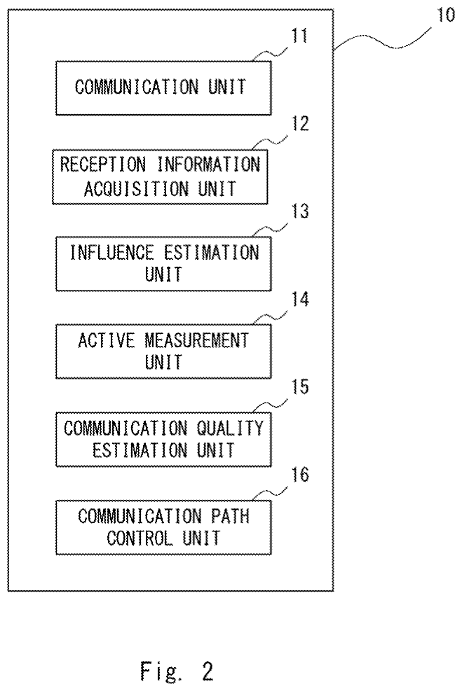

Next, the communication apparatus 10 according to this example embodiment will be described. FIG. 2 is a block diagram showing a configuration example of the communication apparatus according to this example embodiment. As shown in FIG. 2, the communication apparatus 10 according to this example embodiment includes a communication unit 11, a reception information acquisition unit 12, an influence estimation unit 13, an active measurement unit 14, a communication quality estimation unit 15, and a communication path control unit 16.

The communication unit 11 is configured to be able to communicate with the plurality of access points 61_1 to 60_n (see FIG. 1). For example, the communication unit 11 can communicate with the plurality of access points 61_1 to 60_n (see FIG. 1) using the communication scheme in accordance with the specifications of IEEE 802.11. In addition, the communication unit 11 communicates using radio waves in a predetermined frequency band. This frequency band includes a plurality of frequency channels. The number of the communication unit 11 may be one or more.

The reception information acquisition unit 12 acquires reception information about the communication unit 11. Here, the reception information is at least one of, for example, a frequency, a Received Signal Strength Indicator (RSSI), a Signal to Noise Ratio (SNR), and a communication rate used by the communication unit 11.

Based on the reception information acquired by the reception information acquisition unit 12, the influence estimation unit 13 estimates an influence on the current communication when the communication unit 11 performs active measurement. Here, the current communication is the communication (communication path) in which the communication unit 11 is actually communicating with a predetermined access point 61. The influence estimation unit 13 estimates the influence on the current communication when the communication unit 11 performs the active measurement (test communication) separately from the current communication.

For example, the influence estimation unit 13 estimates a degree of interference with the current communication when the communication unit 11 performs the active measurement based on the reception information acquired by the reception information acquisition unit 12. For example, the influence estimation unit 13 estimates the degree of interference with the current communication when the active measurement is performed based on the frequency band where the communication unit 11 performs the active measurement (test communication) and the frequency band where the communication unit 11 performs the current communication.

The active measurement unit 14 performs the active measurement (test communication) based on an estimation result of the influence estimation unit 13. At this time, the active measurement unit 14 sets a condition for performing the active measurement based on the estimation result of the influence estimation unit 13. For example, the active measurement unit 14 sets a condition under which the degree of interference with the current communication when the active measurement is performed can be kept lower than or equal to a certain level. For example, the active measurement unit 14 may set at least one of an amount of data, the number of transmissions, and the frequency band (i.e., upper and lower limit values of the frequency band, etc.) when the active measurement is performed based on the estimation result of the influence estimation unit 13.

For example, the active measurement unit 14 may increase the amount of data when the active measurement is performed if it is estimated that the influence of the active measurement on the current communication is small, whereas the active measurement unit 14 may decrease the amount of data when the active measurement is performed if it is estimated that the influence of the active measurement on the current communication is large. By adjusting the amount of data when the active measurement is performed in this way, the influence of the active measurement on the current communication can be reduced.

Further, the active measurement unit 14 may increase the number of transmissions when the active measurement is performed if it is estimated that the influence of the active measurement on the current communication is small, whereas the active measurement unit 14 may decrease the number of transmissions when the active measurement is performed if it is estimated that the influence of the active measurement on the current communication is large. By adjusting the number of transmissions when the active measurement is performed in this way, the influence of the active measurement on the current communication can be reduced.

In addition, the active measurement unit 14 may use a frequency band in which the influence of the active measurement on the current communication is small for the active measurement. That is, the active measurement unit 14 may use a frequency band that does not interfere with the frequency band in which the communication unit 11 performs the current communication (or a frequency band in which the degree of interference, if it interferes, is low) as the frequency band used for the active measurement.

The above parameters set by the active measurement unit 14 when performing the active measurement are an example, and the active measurement unit 14 may set parameters other than the above parameters in this example embodiment. In addition, the active measurement unit 14 may not perform the active measurement when the influence estimation unit 13 estimates that the active measurement has a large influence on the current communication.

The communication quality estimation unit 15 estimates communication quality based on the reception information acquired by the reception information acquisition unit 12 and the measurement result of the active measurement unit 14. For example, the communication quality estimation unit 15 can estimate that the communication quality of the communication unit 11 is high when the received strength (RSSI), which is the reception information acquired by the reception information acquisition unit 12, is high, when the signal-to-noise ratio (SNR) is high, or when the communication rate is high. Conversely, the communication quality estimation unit 15 can estimate that the communication quality of the communication unit 11 is low when the received strength (RSSI), which is the reception information acquired by the reception information acquisition unit 12, is low, when the signal-to-noise ratio (SNR) is low, or when the communication rate is low.

The communication quality estimation unit 15 estimates the communication quality also based on the measurement result of the active measurement (test communication) performed by the active measurement unit 14. For example, the communication quality estimation unit 15 can estimate that the communication quality of the communication unit 11 is high when the received strength (RSSI) during the active measurement is high, when the signal-to-noise ratio (SNR) during the active measurement is high, or when the communication rate during the active measurement is high. Conversely, the communication quality estimation unit 15 can estimate that the communication quality of communication unit 11 is low when the received intensity (RSSI) during the active measurement is low, when the signal-to-noise ratio (SNR) during the active measurement is low, or when the communication rate during the active measurement is low.

At this time, the communication quality estimation unit 15 estimates the communication quality comprehensively using the reception information acquired by the reception information acquisition unit 12 and the measurement result of the active measurement unit 14. For example, if the amount of data and the number of transmissions when the active measurement is performed are reduced because the influence estimation unit 13 has estimated that the active measurement has a large influence on the current communication, the accuracy of the measurement result of the active measurement is reduced. In this case, the communication quality estimation unit 15 may estimate the communication quality taking into account that the accuracy of the measurement result of the active measurement is reduced. In other words, the communication quality estimation unit 15 may estimate the communication quality by lowering the weighting of the measurement result of the active measurement when the influence estimation unit 13 estimates that the influence of the active measurement on the current communication is large.

For example, when the influence estimation unit 13 estimates that the active measurement has a large influence on the current communication and therefore the active measurement is not performed, the communication quality estimation unit 15 estimates the communication quality using the reception information acquired by the reception information acquisition unit 12 (without using the measurement result of the active measurement). In this case, since the communication quality estimation unit 15 cannot take into account the measurement result of the active measurement, the communication quality estimation unit 15 may estimate the communication quality by evaluating the reception information to be lower than that when the measurement result of the active measurement is taken into account.

The communication path control unit 16 controls the communication paths between the communication unit 11 and the plurality of access points 61_1 to 60_n (see FIG. 1) based on the communication quality estimated by the communication quality estimation unit 15. For example, when the communication unit 11 has a plurality of communication units, the communication path control unit 16 performs control to switch the communication paths from the communication unit performing the current communication to the communication unit estimated to have the higher communication quality, if the communication quality estimated by the communication quality estimation unit 15 is higher than that of the communication unit performing the current communication. That is, the current communication unit may be switched to the communication unit estimated to have the higher communication quality.

When there is only one communication unit 11, the communication unit 11 communicates with the plurality of access points 60 using the plurality of frequency channels. In this case, the active measurement unit 14 performs the active measurement for each frequency channel, and the communication quality estimation unit 15 estimates the communication quality of each frequency channel. When there is only one communication unit 11, the communication path control unit 16 may perform handover processing using the communication quality estimated by the communication quality estimation unit 15.

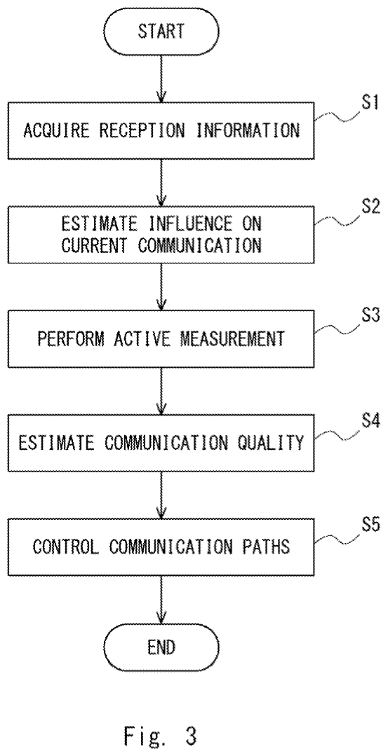

Next, an operation (communication method) of the communication apparatus according to this example embodiment will be described. FIG. 3 is a flowchart for explaining the operation of the communication apparatus according to this example embodiment. It is assumed that the communication apparatus 10 is moving while performing current communication with a predetermined access point 60.

First, the reception information acquisition unit 12 acquires the reception information about the communication unit 11 (Step S1). Here, the reception information is at least one of, for example, the frequency, the Received Signal Strength Indicator (RSSI), the Signal to Noise Ratio (SNR), and the communication rate used by the communication unit 11.

Next, based on the reception information acquired by the reception information acquisition unit 12, the influence estimation unit 13 estimates the influence on the current communication when the communication unit 11 performs the active measurement (Step S2). That is, the influence estimation unit 13 estimates the influence on the current communication when the communication unit 11 performs the active measurement (test communication) separately from the current communication. For example, the influence estimation unit 13 estimates the degree of interference with the current communication when the communication unit 11 performs the active measurement based on the reception information acquired by the reception information acquisition unit 12.

Next, the active measurement unit 14 performs the active measurement (test communication) based on the estimation result of the influence estimation unit 13 (Step S3). At this time, the active measurement unit 14 sets the condition for performing the active measurement based on the estimation result of the influence estimation unit 13. For example, the active measurement unit 14 sets the condition under which the degree of interference with current communication when the active measurement is performed can be kept lower than or equal to a certain level. The active measurement unit 14 may set at least one of the amount of data, the number of transmissions, and the frequency band when the active measurement is performed based on the estimation result of the influence estimation unit 13. Note that the active measurement unit 14 may not perform the active measurement when the influence estimation unit 13 estimates that the active measurement has a large influence on the current communication.

Next, the communication quality estimation unit 15 estimates the communication quality based on the reception information acquired by the reception information acquisition unit 12 and the measurement result of the active measurement unit 14 (Step S4). At this time, the communication quality estimation unit 15 estimates the communication quality comprehensively using the reception information acquired by the reception information acquisition unit 12 and the measurement result of the active measurement unit 14. For example, if the amount of data and the number of transmissions when the active measurement is performed are reduced because the influence estimation unit 13 has estimated that the active measurement has a large influence on the current communication, the accuracy of the measurement result of the active measurement is reduced. In this case, the communication quality estimation unit 15 may estimate the communication quality taking into account that the accuracy of the measurement result of the active measurement is reduced.

For example, when the influence estimation unit 13 estimates that the active measurement has a large influence on the current communication and therefore the active measurement is not performed, the communication quality estimation unit 15 estimates the communication quality using the reception information acquired by the reception information acquisition unit 12 (without using the measurement result of the active measurement). In this case, since the communication quality estimation unit 15 cannot take into account the measurement result of the active measurement, the communication quality estimation unit 15 may estimate the communication quality by evaluating the reception information to be lower than that when the measurement result of the active measurement is taken into account.

After that, the communication path control unit 16 controls the communication paths between the communication unit 11 and the plurality of access points 61_1 to 60_n (see FIG. 1) based on the communication quality estimated by the communication quality estimation unit 15 (Step S5). For example, the communication path control unit 16 performs control to switch the communication paths from the communication unit performing the current communication to the communication unit estimated to have the higher communication quality, if the communication quality estimated by the communication quality estimation unit 15 is higher than that of the communication unit performing the current communication. That is, the current communication unit may be switched to the communication unit estimated to have the higher communication quality.

As described above, in the automatic transportation system, a mobile body transporting products and materials moves while communicating with the plurality of access points set up in warehouses or manufacturing sites by using the communication apparatus mounted on the mobile body. At this time, the mobile body is controlled remotely by wirelessly communicating with the plurality of access points using the communication apparatus.

However, there has been a problem that if the communication between the communication apparatus and the plurality of access points is unstable, the mobile body cannot be stably controlled. That is, if the mobile body moves outside a coverage area of the access point, if the mobile body moves into a shadow of an obstacle, or if the mobile body moves between the access points, the communication between the communication apparatus and the access points may be disconnected or communication delays may occur. Therefore, there has been a problem that the mobile body could not be stably controlled.

In this example embodiment, the reception information about communication unit 11 is acquired, and based on the acquired reception information, the influence on the current communication when the communication unit 11 performs the active measurement is estimated, and based on the estimated result, the active measurement is performed. Next, the communication quality is estimated based on the reception information and the measurement result of the active measurement, and the communication paths between the communication unit and the plurality of access points is controlled based on the estimated communication quality. In this way, the communication quality can be estimated with high accuracy, because the communication quality is estimated comprehensively using the reception information and the measurement result of the active measurement. Therefore, stable wireless communication can be achieved with the plurality of access points.

### Second Example Embodiment

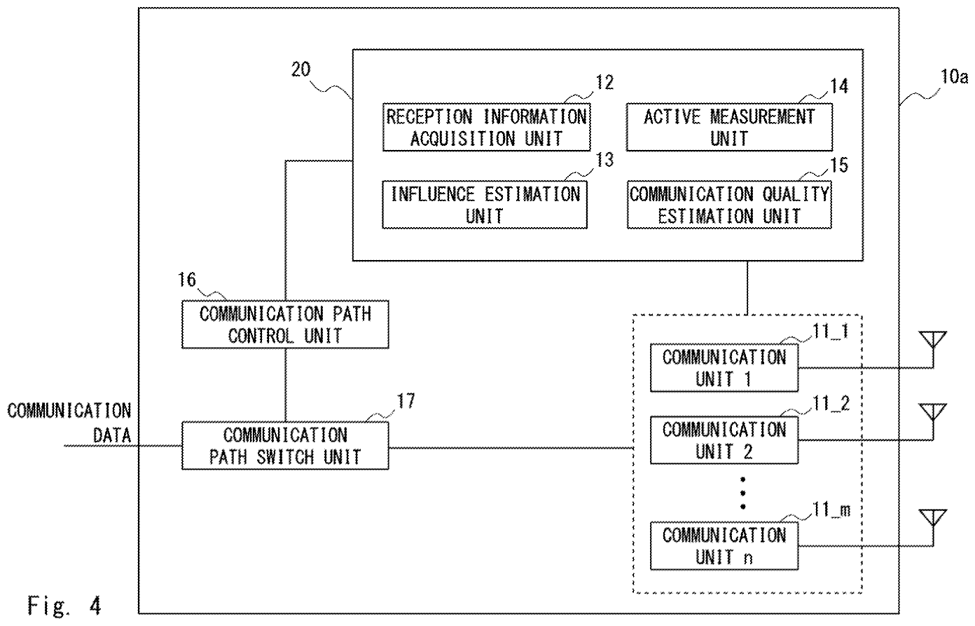

Next, a second example embodiment is explained. The second example embodiment shows a specific configuration example of the communication apparatus 10 described in the first example embodiment. FIG. 4 is a block diagram showing a configuration example of a communication apparatus according to the second example embodiment. Note that in a communication apparatus 10a according to the second example embodiment, the same signs are assigned to the same components as those of the communication apparatus 10 described in the first example embodiment, and repeated descriptions are omitted as appropriate.

As shown in FIG. 4, the communication apparatus 10a according to the second example embodiment includes a plurality of communication units 11_1 to 11_m (m is an integer of two or more), a reception information acquisition unit 12, an influence estimation unit 13, an active measurement unit 14, a communication quality estimation unit 15, a communication path control unit 16, and a communication path switch unit 17. Here, the reception information acquisition unit 12, the influence estimation unit 13, the active measurement unit 14, and the communication quality estimation unit 15 constitute a communication performance estimation unit 20.

The communication apparatus 10a according to this example embodiment includes the plurality of communication units 11_1 to 11_m. The communication quality estimation unit 15 estimates the communication quality of the plurality of communication units 11_1 to 11_m. For example, the communication quality estimation unit 15 may sequentially estimate the communication quality of the plurality of communication units 11_1 to 11_m. The communication path control unit 16 determines a communication unit to be used for current communication among the plurality of communication units 11_1 to 11_m based on the communication quality estimated by the communication quality estimation unit 15. For example, the communication path control unit 16 may perform control to switch the communication unit from the current communication unit to a communication unit whose communication quality is estimated to be high. In this example embodiment, the communication units 11_1 to 11_m may be collectively referred to as communication units 11.

The communication path switch unit 17 switches the communication unit used for current communication among the plurality of communication units 11_1 to 11_m according to the control of the communication path control unit 16. Specifically, the communication path switch unit 17 switches the communication unit so that communication unit corresponding to the communication path determined by the communication path control unit 16 communicates with the access point.

The communication path switch unit 17 is connected in a wired manner to a control unit (not shown) of the mobile body 30 (see FIG. 1) on which the communication apparatus 10a is mounted. Thus, the control signals transmitted from the server 50 (see FIG. 1) are supplied to the control unit of the mobile body 30 via the network 55, the access points 60_1 to 60_n, the communication units 11, and the communication path switch unit 17, thereby controlling the mobile body 30 remotely.

The reception information acquisition unit 12, the influence estimation unit 13, the active measurement unit 14, the communication quality estimation unit 15, and the communication path control unit 16 are the same as those described in the first example embodiment, and thus the repeated descriptions thereof are omitted.

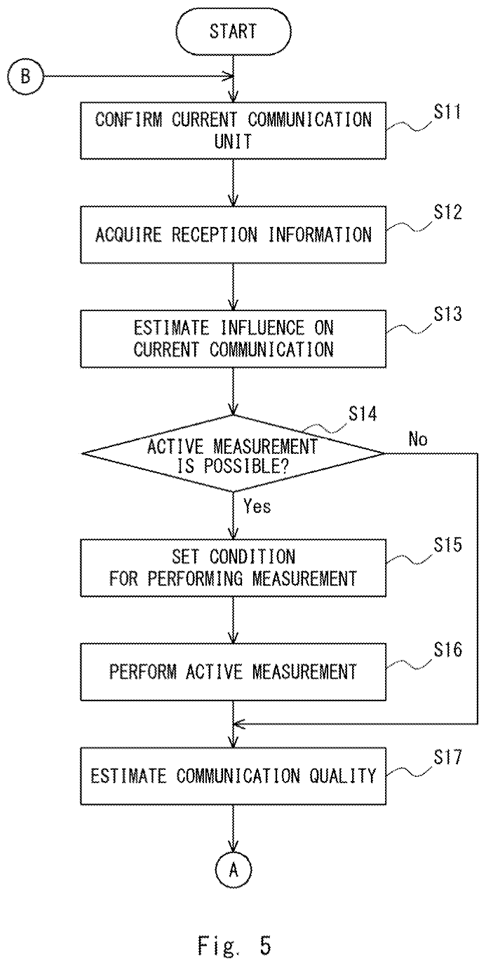

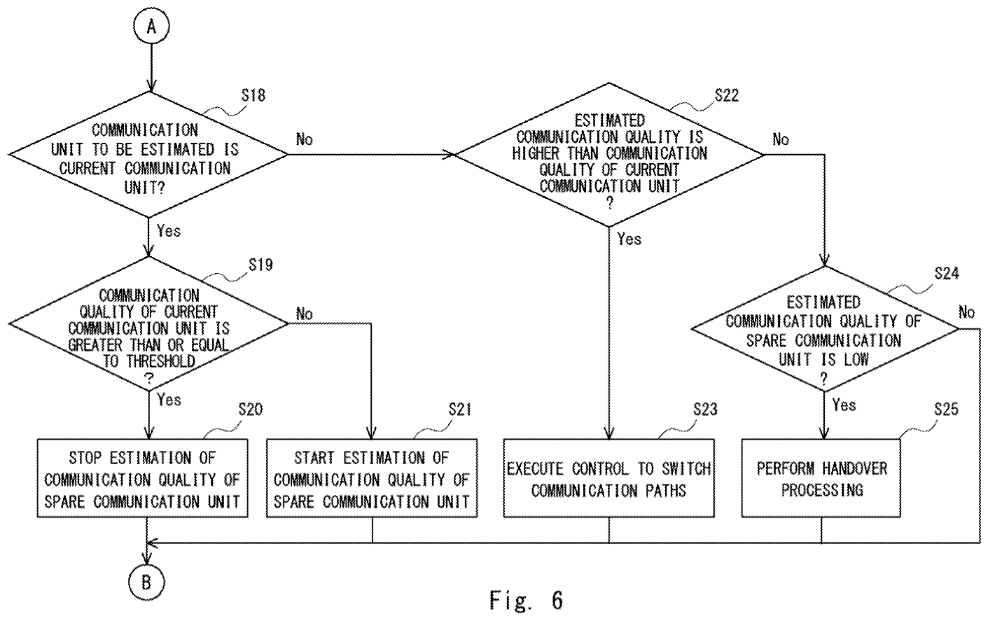

Next, an operation (communication method) of the communication apparatus 10a according to this example embodiment will be described. FIGS. 5 and 6 are flowcharts for explaining the operation of the communication apparatus according to this example embodiment. It is assumed that the communication apparatus 10a moves while performing current communication with a predetermined access point 60 (see FIG. 1).

First, the influence estimation unit 13 confirms the current communication unit 11 (Step S11). For example, the influence estimation unit 13 acquires the information about the current communication unit 11 from the communication path control unit 16. Next, the reception information acquisition unit 12 acquires the reception information about the communication unit 11 for which the communication quality is to be estimated (such a communication unit is hereinafter also referred to as a “communication unit to be estimated”) (Step S12). Here, the reception information is at least one of, for example, the frequency, the Received Signal Strength Indicator (RSSI), the Signal to Noise Ratio (SNR), and the communication rate used by the communication unit 11 to be estimated. Note that the communication unit 11 to be estimated may be a communication unit other than the current communication unit 11 or may be the current communication unit 11.

Next, based on the reception information acquired by the reception information acquisition unit 12, the influence estimation unit 13 estimates the influence on the current communication when the communication unit 11 to be estimated performs the active measurement (Step S13). That is, the influence estimation unit 13 estimates the influence on the current communication when the communication unit 11 to be estimated performs the active measurement (test communication) separately from the current communication. For example, the influence estimation unit 13 estimates the degree of interference with the current communication when the communication unit 11 to be estimated performs the active measurement based on the reception information acquired by the reception information acquisition unit 12.

When the active measurement is possible (Step S14: Yes), the active measurement unit 14 sets the condition for performing the active measurement (Step S15). For example, the active measurement unit 14 sets the condition under which the degree of interference with current communication when the active measurement is performed is kept lower than or equal to a certain level. The active measurement unit 14 may set at least one of the amount of data, the number of transmissions, and the frequency band when the active measurement is performed based on the estimation result of the influence estimation unit 13. After that, the active measurement unit 14 performs the active measurement using the set condition (Step S16).

If it is determined that the active measurement is not possible due to a large degree of interference with the current communication when the active measurement is performed (Step S14: No), the processing proceeds to Step S17 without performing the active measurement.

Next, the communication quality estimation unit 15 estimates the communication quality based on the reception information acquired by the reception information acquisition unit 12 and the measurement result of the active measurement unit 14 (Step S17). At this time, the communication quality estimation unit 15 estimates the communication quality comprehensively using the reception information acquired by the reception information acquisition unit 12 and the measurement result of the active measurement unit 14. For example, if the amount of data and the number of transmissions when the active measurement is performed are reduced because the influence estimation unit 13 has estimated that the active measurement has a large influence on the current communication, the accuracy of the measurement result of the active measurement is reduced. In this case, the communication quality estimation unit 15 may estimate the communication quality taking into account that the accuracy of the measurement result of the active measurement is reduced.

For example, when the influence estimation unit 13 estimates that the active measurement has a large influence on the current communication and therefore the active measurement is not performed (Step S14: No), the communication quality estimation unit 15 estimates the communication quality using the reception information acquired by the reception information acquisition unit 12 (without using the measurement result of the active measurement). In this case, since the communication quality estimation unit 15 cannot take into account the measurement result of the active measurement, the communication quality estimation unit 15 may estimate the communication quality by evaluating the reception information to be lower than that when the measurement result of the active measurement is taken into account.

After that, the communication path control unit 16 controls the communication paths between the communication units 11_1 to 11_m and the plurality of access points 61_1 to 60_n based on the communication quality estimated by the communication quality estimation unit 15. Specifically, as shown in FIG. 6, when the communication unit to be estimated is the current communication unit (Step S18: Yes) and the communication quality of the current communication unit is greater than or equal to a threshold (Step S19: Yes), estimation of communication quality of a spare communication unit (which is a communication unit other than the current communication unit) is stopped (Step S20). That is, in this case, the estimation of the communication quality of the spare communication unit becomes unnecessary, because the communication quality of the current communication unit is satisfactory. The threshold of the determination reference in this case can be set freely by the user.

On the other hand, when the communication unit to be estimated is the current communication unit (Step S18: Yes) and the communication quality of the current communication unit is lower than the threshold (Step S19: No), estimation of the communication quality of the spare communication unit (which is the communication unit other than the current communication unit) is started (Step S21). That is, in this case, since the communication quality of the current communication unit is not satisfactory, estimation of the communication quality of the spare communication unit is started and communication unit to be switched to is searched.

If the communication unit to be estimated is the spare communication unit (Step S18: No) and the estimated communication quality is higher than the communication quality of the current communication unit (Step S22: Yes), the communication path control unit 16 executes control to switch the communication path from the current communication unit to the communication unit to be estimated (Step S23). That is, the communication path is switched from the current communication unit to the communication unit whose communication quality is estimated to be high.

On the other hand, if the communication unit to be estimated is the spare communication unit (Step S18: No), the estimated communication quality is lower than the communication quality of the current communication unit (Step S22: No), and the estimated communication quality of the spare communication unit is low (Step S24: Yes), the communication path control unit 16 performs handover processing using the current communication unit (Step S25). That is, if the communication quality of the spare communication unit is lower than a certain standard, the communication path control unit 16 controls the current communication unit to perform processing to handover to another access point. If the estimated communication quality of the spare communication unit is higher than the certain standard (Step S24: No), the next communication quality estimation processing is performed.

After that, the communication apparatus 10a according to this example embodiment repeats the operations of Steps S11 to S25 shown in FIGS. 5 and 6. The communication path control unit 16 keeps the latest value of the communication quality estimated by the communication quality estimation unit 15, compares the communication quality of each communication unit 11_1 to 11_m, and controls the optimum communication path to be used for the current communication. In this case, the selection of the communication path may be the one with the largest latest value of the communication quality or the one with the largest moving average value of the communication quality. If the largest latest value of communication quality is selected, a determination reference may be established that the communication quality is superior to that of current communication by a certain degree or more.

Even in the communication apparatus 10a according to this example embodiment described above, stable wireless communication can be performed with the plurality of access points. In the communication apparatus 10a according to this example embodiment shown in FIG. 4, the communication performance estimation unit 20 may be provided outside the communication apparatus 10a. In this case, the communication apparatus 10a can acquire information about the communication quality of the communication unit 11 by communicating with the communication performance estimation unit 20 provided outside.

In addition, although the configuration of the hardware has been described in the above example embodiments, the present disclosure is not limited to this. The present disclosure can also achieve the above communication processing by making the CPU execute a computer program.

Also, in the above example embodiments, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The disclosure is not limited to the above example embodiments and can be changed as appropriate without departing from the purport. In addition, the disclosure may be implemented by combining each example embodiment as appropriate.

The whole or part of the example embodiments disclosed above can be described as, but not limited to, the following supplementary notes.

### (Supplementary Note 1)

A communication apparatus comprising:
a communication unit configured to be able to communicate with a plurality of access points;
a reception information acquisition unit configured to acquire reception information about the communication unit;
an influence estimation unit configured to estimate an influence on current communication when the communication unit performs active measurement based on the reception information acquired by the reception information acquisition unit;
an active measurement unit configured to perform the active measurement based on a result of the estimation by the influence estimation unit;
a communication quality estimation unit configured to estimate communication quality based on the reception information and a result of the measurement by the active measurement unit; and
a communication path control unit configured to control communication paths between the communication unit and the plurality of access points based on the communication quality estimated by the communication quality estimation unit.

### (Supplementary Note 2)

The communication apparatus according to Supplementary note 1, wherein
the active measurement unit is configured to set a condition for performing the active measurement based on a result of the estimation by the influence estimation unit.

### (Supplementary Note 3)

The communication apparatus according to Supplementary note 1 or 2, wherein
the influence estimation unit is configured to estimate a degree of interference with the current communication when the communication unit performs the active measurement based on the reception information acquired by the reception information acquisition unit.

### (Supplementary Note 4)

The communication apparatus according to any one of Supplementary notes 1 to 3, wherein
the communication unit is composed of a plurality of communication units.

### (Supplementary Note 5)

The communication apparatus according to Supplementary note 4, wherein
when the communication quality estimated by the communication quality estimation unit is higher than the communication quality of the communication unit performing the current communication, the communication path control unit is configured to perform control to switch the communication paths from the communication unit performing the current communication to the communication unit estimated to have the higher communication quality.

### (Supplementary Note 6)

The communication apparatus according to any one of Supplementary notes 1 to 5, wherein
the reception information is at least one of a frequency, a received intensity, a signal-to-noise ratio, and a communication rate used by the communication unit.

### (Supplementary Note 7)

The communication apparatus according to any one of Supplementary notes 1 to 6, wherein
the active measurement unit is configured to set at least one of an amount of data, the number of transmissions, and a frequency band in performing the active measurement based on the result of the estimation by the influence estimation unit.

### (Supplementary Note 8)

The communication apparatus according to Supplementary note 7, wherein
the active measurement unit is configured to increase the amount of data when the active measurement is performed if it is estimated that the influence of the active measurement on the current communication is small, whereas the active measurement unit is configured to decrease the amount of data when the active measurement is performed if it is estimated that the influence of the active measurement on the current communication is large.

### (Supplementary Note 9)

The communication apparatus according to Supplementary note 7 or 8, wherein
the active measurement unit is configured to increase the number of transmissions when the active measurement is performed if it is estimated that the influence of the active measurement on the current communication is small, whereas the active measurement unit is configured to decrease the number of transmissions when the active measurement is performed if it is estimated that the influence of the active measurement on the current communication is large.

### (Supplementary Note 10)

The communication apparatus according to any one of Supplementary notes 1 to 9, wherein
the communication quality estimation unit is configured to estimate the communication quality by lowering weighting of the result of the measurement of the active measurement when the influence estimation unit estimates that the influence of the active measurement on the current communication is large.

### (Supplementary Note 11)

A communication system comprising:
a plurality of access points;
a server connected to the plurality of access points via a network;
the communication apparatus according to any one of Supplementary notes 1 to 10; and
a mobile body on which the communication apparatus is mounted, wherein
when the mobile body moves, the communication apparatus moves while switching communication paths between the communication apparatus and the plurality of access points.

### (Supplementary Note 12)

A communication method comprising:
acquiring reception information about a communication unit configured to be able to communicate with a plurality of access points;
estimating an influence on current communication when the communication unit performs active measurement based on the acquired reception information;
performing the active measurement based on a result of the estimation of the influence on the current communication;
estimating communication quality based on the reception information and a result of the measurement of the active measurement; and
controlling communication paths between the communication unit and the plurality of access points based on the estimated communication quality.

### (Supplementary Note 13)

A non-transitory computer readable medium storing a program for causing a computer to execute communication processing comprising:
processing of acquiring reception information about a communication unit configured to be able to communicate with a plurality of access points;
processing of estimating an influence on current communication when the communication unit performs active measurement based on the acquired reception information;
processing of performing the active measurement based on a result of the estimation of the influence on the current communication;
processing of estimating communication quality based on the reception information and a result of the measurement of the active measurement; and
processing of controlling communication paths between the communication unit and the plurality of access points based on the estimated communication quality.

### REFERENCE SIGNS LIST

1 COMMUNICATION SYSTEM
10, 10a COMMUNICATION APPARATUS
11, 11_1 to 11_m COMMUNICATION UNIT
12 RECEPTION INFORMATION ACQUISITION UNIT
13 INFLUENCE ESTIMATION UNIT
14 ACTIVE MEASUREMENT UNIT
15 COMMUNICATION QUALITY ESTIMATION UNIT
16 COMMUNICATION PATH CONTROL UNIT
17 COMMUNICATION PATH SWITCH UNIT
20 COMMUNICATION PERFORMANCE ESTIMATION UNIT
30 MOBILE BODY
50 SERVER
55 NETWORK
60_1 to 60_n ACCESS POINT

What is claimed is:

1. A communication apparatus comprising:
a communication unit configured to be able to communicate with a plurality of access points;
a reception information acquisition unit configured to acquire reception information about the communication unit;
an influence estimation unit configured to estimate an influence on current communication when the communication unit performs active measurement based on the reception information acquired by the reception information acquisition unit;
an active measurement unit configured to perform the active measurement based on a result of the estimation by the influence estimation unit;
a communication quality estimation unit configured to estimate communication quality based on the reception information and a result of the measurement by the active measurement unit; and
a communication path control unit configured to control communication paths between the communication unit and the plurality of access points based on the communication quality estimated by the communication quality estimation unit.

2. The communication apparatus according to claim 1, wherein
the active measurement unit is configured to set a condition for performing the active measurement based on a result of the estimation by the influence estimation unit.

3. The communication apparatus according to claim 1, wherein
the influence estimation unit is configured to estimate a degree of interference with the current communication when the communication unit performs the active measurement based on the reception information acquired by the reception information acquisition unit.

4. The communication apparatus according to claim 1, wherein
the communication unit is composed of a plurality of communication units.

5. The communication apparatus according to claim 4, wherein
when the communication quality estimated by the communication quality estimation unit is higher than the communication quality of the communication unit performing the current communication, the communication path control unit is configured to perform control to switch the communication paths from the communication unit performing the current communication to the communication unit estimated to have higher communication quality.

6. The communication apparatus according to claim 1, wherein
the reception information is at least one of a frequency, a received intensity, a signal-to-noise ratio, and a communication rate used by the communication unit.

7. The communication apparatus according to claim 1, wherein
the active measurement unit is configured to set at least one of an amount of data, the number of transmissions, and a frequency band in performing the active measurement based on the result of the estimation by the influence estimation unit.

8. A communication system comprising:
a plurality of access points;
a server connected to the plurality of access points via a network;
the communication apparatus according to claim 1; and
a mobile body on which the communication apparatus is mounted, wherein
when the mobile body moves, the communication apparatus moves while switching communication paths between the communication apparatus and the plurality of access points.

9. A communication method comprising:
acquiring reception information about a communication unit configured to be able to communicate with a plurality of access points;
estimating an influence on current communication when the communication unit performs active measurement based on the acquired reception information;
performing the active measurement based on a result of the estimation of the influence on the current communication;
estimating communication quality based on the reception information and a result of the measurement of the active measurement; and
controlling communication paths between the communication unit and the plurality of access points based on the estimated communication quality.

10. A non-transitory computer readable medium storing a program for causing a computer to execute communication processing comprising:
processing of acquiring reception information about a communication unit configured to be able to communicate with a plurality of access points;
processing of estimating an influence on current communication when the communication unit performs active measurement based on the acquired reception information;
processing of performing the active measurement based on a result of the estimation of the influence on the current communication;
processing of estimating communication quality based on the reception information and a result of the measurement of the active measurement; and
processing of controlling communication paths between the communication unit and the plurality of access points based on the estimated communication quality.

11. The communication apparatus according to claim 7, wherein
the active measurement unit is configured to increase the amount of data when the active measurement is performed if it is estimated that the influence of the active measurement on the current communication is small, whereas the active measurement unit is configured to decrease the amount of data when the active measurement is performed if it is estimated that the influence of the active measurement on the current communication is large.

12. The communication apparatus according to claim 7, wherein
the active measurement unit is configured to increase the number of transmissions when the active measurement is performed if it is estimated that the influence of the active measurement on the current communication is small, whereas the active measurement unit is configured to decrease the number of transmissions when the active measurement is performed if it is estimated that the influence of the active measurement on the current communication is large.

13. The communication apparatus according to claim 1, wherein
the communication quality estimation unit is configured to estimate the communication quality by lowering weighting of the result of the measurement of the active measurement when the influence estimation unit estimates that the influence of the active measurement on the current communication is large.
